(19) United States
(12) Patent Application Publication
(10) Pub. No.: US 2011/0232907 A1
(43) Pub. Date: Sep. 29, 2011

(54) LAMINAR PHASE RING FOR FLUID TRANSPORT APPLICATIONS

(76) Inventors: Jason E. Bryant, Duncan, OK (US); David E. McMechan, Duncan, OK (US); Thomas D. Welton, Duncan, OK (US); Malcolm S. Talbot, Duncan, OK (US); Corine L. McMechan, Duncan, OK (US)

(21) Appl. No.: 12/731,260

(22) Filed: Mar. 25, 2010

(51) Int. Cl. E21B 43/00; E21B 47/00; F17D 1/00

(52) U.S. Cl. 166/300; 137/2

(57) ABSTRACT

Methods for creating and using multi-phase fluid flows are disclosed. In one embodiment, such a method includes introducing an inner fluid into a tubular conduit. The method further includes introducing a ring fluid into the tubular conduit. In this embodiment, the ring fluid is disposed annularly between the inner fluid and the interior of the tubular conduit, and the flow of the ring fluid is laminar.

### BACKGROUND

The present invention relates to transportation of fluids through tubular conduits, and, at least in some embodiments, to multi-phase fluid flows and associated methods of use.

During various applications, such as the drilling, completion, and stimulation of subterranean wells, fluids are often transported through tubular conduits (e.g., pipes, hoses, tubing, casings, open hole well bore, rubber hose, steel pipe, PVC pipe, surface piping, coiled tubing, well bore casing, jointed pipe, spaghetti string, etc.). Other such applications also may include the transportation of fluids through overland and/or submerged pipelines. A considerable amount of energy may be lost due to friction between the fluids and the tubular conduits, especially when the fluids exhibit turbulent flow. As a result of these energy losses, increased pumping pressure and high hydraulic horsepower may be necessary to transport a fluid through a tubular conduit at a desired rate. For some fluids, the required pressure may be near the maximum permissible for standard tubular conduit and pumping equipment.

Friction can be a particularly severe problem for fracturing fluids, since frictional energy loss may tend to increase with fluid viscosity. A fracturing fluid is often required to have a sufficiently high viscosity in order to propagate through a wide and long fracture in a formation and to transport proppant into the fracture. Friction can also be a problem for matrix fluids. During matrix treatments, matrix fluids are typically pumped such that the pressure in the formation generally remains at or below the formation fracture gradient. Nonetheless, the viscosity of matrix fluids tend to be similar to that of fracturing fluids, thereby resulting in somewhat similar energy losses due to friction.

To reduce the frictional energy losses in a variety of fluids, friction reducing agents have heretofore been utilized. Friction reducing agents tend to alter the fluid rheological properties to reduce friction created within the fluid as it flows through tubular conduits. Generally polymers, friction reducing agents may add viscosity to the fluid, which may reduce the turbulence induced as the fluid flows. Such additives tend to be more effective at high flow rates where the fluid flow is more turbulent. However, it is believed that the ionic nature of certain friction reducing agents may cause interactions with formation fines and/or salts, and thereby form flocs, which may decrease the performance of friction reducing agents. The resulting flocs may also facilitate the formation of agglomerates that may clog pumps, filters, surface equipment, and possibly fractures. Moreover, many friction reducing agents, such as oil-external emulsion polymers, may create environmental challenges.

Water impurities and chemical additives may greatly compromise the performance of friction reducing agents. This may be especially problematic in operations involving the use of produced and/or recycled water. For example, produced and/or recycled water tends to have high hydrocarbon content. Moreover, biocides are frequently added to produced and/or recycled water prior to well treatment. Therefore, traditional friction reducing agents may not perform well in operations involving the use of produced and/or recycled water.

One type of well treatment that may utilize friction reducing agents is commonly referred to as “high-rate water fracturing” or “water frac.” One example of high-rate water fracturing is AQUASTIM^{SM} Water Frac Service, available from Halliburton Energy Services. Inc. of Duncan, Okla. Unlike many fracturing fluids, fluids used in high-rate water fracturing generally do not contain a sufficient amount of a water-soluble polymer to form a gel. As a result, the fluids used in these high-rate water fracturing operations generally have a lower viscosity than traditional fracturing fluids. Additionally, while fluids used in high-rate water fracturing may contain a friction reducing agent, the friction reducing agent is generally included in an amount insufficient to form a gel.

Fluids used in subterranean operations also may include proppant particulates. When transported through tubular conduits, the proppant in the fluids may scratch the interior surface of the tubular conduit in a process known as “proppant erosion.” Irregularities in the surface of the tubular conduit from proppant erosion may further contribute to frictional energy loss, generate turbulence in the fluid flow, and, ultimately, provide a weakening of the tubular conduit that could permit fluid leakage.

Acidic fluids are frequently used in subterranean operations (e.g., acidizing, acid fracturing) and may be designed to achieve delayed acidization. In acid fracturing, the acid should not attack well bore tubular conduits or be rapidly consumed in the area of the formation immediately adjacent the well bore. Often, an emulsion may be used in acid fracturing because it may have inherent viscosity, and the rate of reaction with acid soluble materials in the subterranean formation may be more easily controlled. For instance, potential corrosion problems may be managed by using an oil external phase. Corrosion inhibitors also may be used to protect the tubular conduits. However, corrosion inhibitors may be too expensive to be utilized as an external phase in an emulsion.

Many subterranean operations attempt to limit fluid treatments to one or more specific zones. For example, certain chemical reactions may be timed, through the use of buffers or activators, to substantially occur only during a designated interval following introduction into the tubular conduit. In other instances, degradable coatings may be applied to reactive particulates to delay reactions between the particulates and the carrier fluid. Baffles, diverters, and/or remotely controlled sleeves may physically separate multiple reactants until reaching a desired location. Costly reactants may thereby be preserved for consumption at the desired treatment zone. Additionally, safety concerns at the surface may be mitigated by limiting hazardous reactions to deep within the well bore. Enhancements of baffles, diverters, and/or remotely controlled sleeves may be beneficial for separating multiple reactants.

Computational fluid dynamics (“CFD”) technology and software may provide the ability to model multiple fluids in a tubular conduit. However, the technology commonly used in the art has generally been restricted heretofore to modeling only laminar flow or only turbulent flow for all of the fluid components.

### SUMMARY

The present invention relates to transportation of fluids through tubular conduits, and, at least in some embodiments, to multi-phase fluid flows and associated methods of use.

One embodiment of the present invention provides a method related to multi-phase fluid flow. The method comprises introducing an inner fluid into a tubular conduit. The method further comprises introducing a ring fluid into the tubular conduit, wherein the ring fluid is disposed annularly between the inner fluid and the interior of the tubular conduit, and wherein the flow of the ring fluid is laminar.

In another embodiment, the present invention provides another method related to multi-phase fluid flow. The method comprises providing a tubular conduit. The method further comprises providing a first fluid to flow through the tubular conduit. The method further comprises determining an expected friction between the interior of the tubular conduit and the first fluid during flow of the first fluid through the tubular conduit. The method further comprises selecting a second fluid to flow through the tubular conduit so that an expected friction between the interior of the tubular conduit and the second fluid during flow of the second fluid through the tubular conduit would be less than the determined expected friction between the interior of the tubular conduit and the first fluid. In this method, the second fluid is disposed annularly between the first fluid and the interior of the tubular conduit during flow of the second fluid through the tubular conduit, and the flow of the second fluid is laminar.

In yet another embodiment, the present invention provides a method for treating a portion of a subterranean formation. The method comprises providing a treatment zone in a well bore proximate the portion of the subterranean formation. The method further comprises providing a tubular conduit that is disposed in the well bore proximate the treatment zone. The method further comprises introducing an inner fluid into the tubular conduit. The method further comprises introducing a ring fluid into the tubular conduit, wherein the ring fluid is disposed annularly between the inner fluid and the interior of the tubular conduit, and wherein the flow of the ring fluid is laminar. The method further comprises initiating mixing of the inner fluid and the ring fluid at the treatment zone.

The features and advantages of the present invention will be apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 illustrates a schematic of an annular delivery system, according to one embodiment of the invention.

FIG. 2 illustrates data relating to laminar ring thickness and flow rates for some embodiments of the invention.

FIG. 3 illustrates a 2-phase laminar/turbulent flow, with and without turbulent reduction (F), comparing the wall shear rate (\dot{γ}_{w}) and the inner/ring fluid boundary velocity (V_{b}) as a function of the Power Law proportionality constant of the ring fluid (m₂) for one embodiment of the invention.

FIG. 4 illustrates a 2-phase laminar/turbulent flow, with and without turbulent reduction (F), comparing the percent friction reduction (F₁₂) and the ring fluid Reynolds number (Re₂) as a function of the Power Law proportionality constant of the ring fluid (m₂) for one embodiment of the invention.

FIG. 5 illustrates a 2-phase laminar/turbulent flow, with and without turbulent reduction (F), comparing the ring fluid flow rate (Q₂) and the inner fluid flow rate (Q₁) as a function of the Power Law proportionality constant of the ring fluid (m₂) for one embodiment of the invention.

FIG. 6 illustrates a 2-phase laminar/laminar flow comparing the wall shear rate (\dot{γ}_{w}) and the inner/ring fluid boundary velocity (V_{b}) as a function of the Power Law proportionality constant of the ring fluid (m₂) for one embodiment of the invention.

FIG. 7 illustrates a 2-phase laminar/laminar flow comparing the percent friction reduction (F₁₂) and the ring fluid Reynolds number (Re₂) as a function of the Power Law proportionality constant of the ring fluid (m₂) for one embodiment of the invention.

FIG. 8 illustrates a 2-phase laminar/laminar flow comparing the ring fluid flow rate (Q₂) and the inner fluid flow rate (Q₁) as a function of the Power Law proportionality constant of the ring fluid (m₂) for one embodiment of the invention.

### DESCRIPTION OF PREFERRED EMBODIMENTS

The present invention relates to transportation of fluids through tubular conduits, and, at least in some embodiments, to multi-phase fluid flows and associated methods of use.

In accordance with embodiments of the present invention, a method may comprise introducing a first fluid, or “inner fluid,” into a tubular conduit; and introducing a second fluid, or “ring fluid,” into the tubular conduit, wherein the second (ring) fluid is disposed annularly between the first (or inner) fluid and the inner wall of the tubular conduit, and wherein the flow of the second (or ring) fluid is laminar. As used herein, the terms “laminar” and “laminar flow” refer to generally streamline flow of a fluid wherein any given subcurrent moves generally in parallel with any other nearby subcurrent. Laminar flow may be generally demonstrated through simulations employing standard computational fluid dynamics (“CFD”) as applied to a given fluid composition and a given tubular conduit geometry. For example, for a given fluid rheology and tubular geometry, the approximate Reynolds number transition between laminar and turbulent flow may be determined by CFD, experiment, or both. As used herein, “tubular conduit” refers to any continuous length of conduit through which fluid flows, including, but not limited to, pipes, hoses, tubing, casings, open hole well bore, rubber hose, steel pipe, PVC pipe, surface piping, coiled tubing, well bore casing, jointed pipe, and spaghetti string. In some embodiments, there may be more than two fluids, thereby forming multiple rings. One of the many potential advantages of the methods of the present invention, only some of which are discussed herein, is that friction encountered by the inner fluid flowing through the tubular conduit may be reduced by a laminar phase ring fluid disposed between the inner fluid and the tubular conduit. In subterranean operations, this method may greatly reduce the friction encountered by the inner fluid and thereby potentially allow increased pumping rates, reduced pumping horsepower, and/or reduced chemical loadings. Increased pumping rates may provide cost savings by reducing the time and equipment costs required to deliver the desired fluid volume downhole. This may likewise provide more flexibility in designing jobs due to the availability of higher flow rates. For example, it is believed that the methods of the present invention may reduce the required pumping time for operations using emulsified acids by about 50% in certain embodiments. Costs savings also may result from a reduction in quantity of friction reducing agent required, as only the ring fluid, rather than the entire fluid volume, may be treated. The term “friction reducing agent,” as used herein, refers to an agent that reduces frictional losses due to friction between a fluid and itself, a tubular conduit, and/or the formation. In some embodiments, these friction reducing agents may comprise synthetic polymers, natural polymers, and/or surfactants.

Another potential advantage is that proppant erosion, corrosion, and surface degradation on the interior of the tubular conduit caused by the inner fluid flowing through the tubular conduit may be reduced by the laminar phase ring fluid disposed between the inner fluid and the tubular conduit. For example, a ring fluid comprising a friction reducing agent may reduce proppant erosion, corrosion, and surface degradation that would otherwise be expected with an inner fluid comprising proppant. This result may be especially evident when the inner fluid is acidic and the ring fluid includes a corrosion inhibitor. Again, costs savings also may result from a reduction in quantity of corrosion inhibitors required.

Yet another potential advantage is that mixing between the inner fluid and the ring fluid flowing through the tubular conduit may be delayed by maintaining the ring fluid in laminar flow. In subterranean operations, mixing may thus be controlled as a function of time or of depth. In some embodiments, delayed mixing may provide improved safety as personnel on the surface are not directly exposed to byproducts and energies released by the mixing of the fluids. This may be beneficial in certain applications, for example, when utilizing exothermic chemical reactions such as those described in U.S. Pat. Nos. 4,330,037, 4,410,041 and 6,992,048, each of which is incorporated herein by reference. In some applications, this enhanced safety feature may allow for stronger oxidizers/breakers to be utilized. Delayed mixing also may be advantageous in distributed temperature survey (“DTS”) applications, such as those described in U.S. Pat. No. 7,398,680 and U.S. Patent Application Serial Nos. 2008/0264162, 2008/0264163, each of which is incorporated herein by reference. In such applications, the position, displacement, and flow rate of a fluid downhole may be measured by observing a temperature gradient change. For example, the temperature gradient may be created by simultaneously flowing two fluids with substantially different initial temperature, specific heat, density, and/or product of specific heat and density. The interface between the two fluids may result in a distinguishable temperature gradient in the well bore. The methods of the present invention may allow deeper DTS applications as the interface between the two fluids, and hence the temperature gradient, may be maintained over longer times and greater depths due to the laminar flow of the ring fluid. In some embodiments, real time observation of the temperature gradient change may allow for timely adjustments to well treatment plans. Other applications which may benefit from delayed mixing of fluids include the downhole use of catalysts and breakers, reactors and activators, and various other incompatible compounds (e.g., hydrocarbons or glycols and viscoelastic fluids).

In some embodiments, both the first (or inner) fluid and the second (or ring) fluid may be characterized by laminar flow in a generally circular tube represented by cylindrical coordinates r, θ, and z. As would be understood by one of ordinary skill in the art with the benefit of this disclosure, when simultaneously modeling the two fluids, wherein both fluids may be characterized by laminar flow, the boundary conditions may be stated as:

$$\begin{matrix}{V}_{2 , z} ( r = R ) = 0. & Eq . 1 \\ {τ}_{1 , zr} ( r = 0 ) = 0. & Eq . 2 \\ {V}_{1 , z} ( r = ( 1 - κ ) R ) = {V}_{2 , z} ( r = ( 1 - κ ) R ) . & Eq . 3 \\ {τ}_{1 , zr} ( r = ( 1 - κ ) R ) = {τ}_{2 , zr} ( r = ( 1 - κ ) R ) . & Eq . 4 \\ \frac{\partial p}{\partial z} = \frac{d p}{d z} = \frac{Δ P}{L} . & Eq . 5\end{matrix}$$

wherein R, the radius of the tubular conduit, K, the radial thickness of the laminar phase ring as a percentage of the radius of the tubular conduit, ρ₁, the density of the inner fluid, ρ₂, the density of the ring fluid, m₁, the power-law proportionality constant of the inner fluid, m₂, the power-law proportionality constant of the ring fluid, n₁, the power-law exponent constant of the inner fluid, n₂, the power-law exponent constant of the ring fluid, and Q, the total steady-state flow rate of the two fluids may all be known. In these equations, p represents the local gauge pressure; V_{1,z} represents the local velocity of the inner fluid; V_{2,z} represents the local velocity of the ring fluid; τ_{1,zr} represents the local shear stress of the inner fluid; and τ_{2,zr} represents the local shear stress of the ring fluid. Three unknowns,

$$\frac{Δ P}{L} ,$$

the constant pressure drop for two-phase laminar flow in the tubular conduit, Q₁, the steady-state flow rate for the inner fluid, and Q₂, the stead-state flow rate for the ring fluid, may be determined by solving the following three independent equations:

$$\begin{matrix}{Q}_{1} = {π ( \frac{Δ P}{L} \frac{R}{2 {m}_{2}} )}^{1 / {n}_{2}} [ 1 - {( 1 - κ )}^{1 / {n}_{2} + 1} ] \frac{{( 1 - κ )}^{2} {R}^{3}}{1 / {n}_{2} + 1} + 2 {π ( \frac{Δ P}{L} \frac{( 1 - κ ) R}{2 {m}_{1}} )}^{1 / {n}_{2}} [ \frac{1}{2} - \frac{1}{1 / {n}_{1} + 3} ] \frac{{( 1 - κ )}^{3} {R}^{3}}{1 / {n}_{1} + 1} . & Eq . 6 \\ {Q}_{2} = 2 {π ( \frac{Δ P}{L} \frac{R}{2 {m}_{2}} )}^{1 / {n}_{2}} ( \frac{{R}^{3}}{1 / {n}_{2} + 1} ) [ \frac{1 - {( 1 - κ )}^{2}}{2} - \frac{1 - {( 1 - κ )}^{1 / {n}_{2} + 3}}{1 / {n}_{2} + 3} ] . & Eq . 7 \\ Q = {Q}_{1} + {Q}_{2} . & Eq . 8\end{matrix}$$

while other equations of interest include:

$$\begin{matrix}{F}_{12} = \frac{\frac{Δ {P}_{0}}{L} - \frac{Δ P}{L}}{\frac{Δ {P}_{0}}{L}} . & Eq . 9 \\ {V}_{b} = {( \frac{Δ P}{L} \frac{R}{2 {m}_{2}} )}^{1 / {n}_{2}} ( \frac{R}{1 / {n}_{2} + 1} ) [ 1 - {( 1 - κ )}^{1 / {n}_{2} + 1} ] . & Eq . 10 \\ {τ}_{w} = {τ}_{2 , zr} ( r = R ) = \frac{Δ P}{L} \frac{R}{2} . & Eq . 11 \\ {\dot{γ}}_{w} = {( \frac{{τ}_{w}}{{m}_{2}} )}^{\frac{1}{{n}_{2}}} . & Eq . 12 \\ {Re}_{2} = \frac{{ρ}_{2} {Q}_{2}}{π R ( 2 - κ ) {m}_{2} {\dot{γ}}_{w}^{{n}_{2} - 1}} . & Eq . 13 \\ {τ}_{b} = {τ}_{1 , zr} ( r = ( 1 - κ ) R ) = {τ}_{2 , zr} ( r = ( 1 - κ ) R ) = \frac{Δ P}{L} \frac{( 1 - κ ) R}{2} . & Eq . 14 \\ {\dot{γ}}_{1 , b} = {( \frac{{τ}_{b}}{{m}_{1}} )}^{\frac{1}{{n}_{1}}} . & Eq . 15 \\ {Re}_{1} = \frac{2 {ρ}_{1} ( {Q}_{1} - {π ( 1 - κ )}^{2} {R}^{2} {V}_{b} )}{π R ( 1 - κ ) {m}_{1} {γ}_{1 , b}^{{n}_{1} - 1}} . & Eq . 16\end{matrix}$$

wherein F₁₂ represents the percentage friction reduction of this dual-phase laminar stream compared to the friction pressure required to flow the inner laminar phase only with a fluid with density ρ₁ and Power-Law constants m₁ and n₁ and with a flow rate Q through a tubular conduit with radius R (i.e., for the case where κ=0); Re₁ represents the Reynolds number of the inner fluid; Re₂ represents the Reynolds number of the ring fluid; V_{b} represents the boundary velocity at the boundary between the inner fluid and the ring fluid;

$$\frac{Δ {P}_{0}}{L}$$

represents the constant pressure drop for single-phase laminar stream in a tubular conduit (i.e., for the case where κ=0); \dot{γ}_{1,b} represents the inner fluid shear rate at the boundary between the inner fluid and the ring fluid; \dot{γ}_{w} represents the shear rate at the wall of the tubular conduit; τ_{b} represents the shear stress at the boundary between the inner fluid and the ring fluid; and τ_{w} represents the shear stress at the wall of the tubular conduit.

In some embodiments, the first (or inner) fluid may be characterized by turbulent flow, while the second (or ring) fluid may be characterized by laminar flow. As would be understood by one of ordinary skill in the art with the benefit of this disclosure, when simultaneously modeling the two fluids, wherein only the second (or ring) fluid may be characterized by laminar flow, the boundary conditions may be stated as:

$$\begin{matrix}{V}_{2 , z} ( r = R ) = 0. & Eq . 17 \\ {τ}_{1 , zr} ( r = ( 1 - κ ) R ) = {τ}_{2 , zr} ( r = ( 1 - κ ) R ) . & Eq . 18 \\ \frac{\partial p}{\partial z} = \frac{d p}{d z} = \frac{Δ P}{L} . & Eq . 19\end{matrix}$$

wherein R, κ, ρ₁, ρ₂, m₂, n₂, μ₁, the constant viscosity of the inner fluid, ε_{b}, the relative roughness factor of the boundary between the inner and ring fluid, scaled by 2(1−κ)R, εₚ, the relative roughness factor of the tubular conduit, scaled by 2R, and Q may all be known. Five unknowns,

$$\frac{Δ P}{L} ,$$

Q₁, Q₂, V_{b}, the boundary velocity at the laminar-turbulent interface, and Vₜ, the turbulent velocity contribution to the total velocity of the first (or inner) fluid, may be determined by solving the following set of equations:

$$\begin{matrix}\frac{Δ P}{L} = ( 1 - F ) \frac{{ρ}_{1} {V}_{t}^{2} f}{2 {g}_{c} 2 ( 1 - κ ) R} ; \\ f = {\{ - 2 log [ \frac{{ɛ}_{b}}{3.7} - \frac{5.02}{{Re}_{1}} log ( \frac{{ɛ}_{b}}{3.7} + \frac{14.5}{{Re}_{1}} ) ] \}}^{- 2} ; \\ {Re}_{1} = \frac{{ρ}_{1} {V}_{t} 2 ( 1 - κ ) R}{{μ}_{1}} . & Eq . 20 \\ {V}_{b} = {( \frac{Δ P}{L} \frac{R}{2 {m}_{2}} )}^{1 / {n}_{2}} ( \frac{R}{1 / {n}_{2} + 1} ) [ 1 - {( 1 - κ )}^{1 / {n}_{2} + 1} ] . & Eq . 21 \\ {Q}_{1} = {π ( 1 - κ )}^{2} {R}^{2} ( {V}_{t} + {V}_{b} ) . & Eq . 22 \\ {Q}_{2} = 2 {π ( \frac{Δ P}{L} \frac{R}{2 {m}_{2}} )}^{1 / {n}_{2}} ( \frac{{R}_{3}}{1 / {n}_{2} + 1} ) [ \frac{{( 1 - κ )}^{1 / {n}_{2} + 3}}{1 / {n}_{2} + 3} - \frac{{κ}^{2} - 2 κ}{2} - \frac{{1}^{1 / {n}_{2} + 3}}{1 / {n}_{2} + 3} ] . & Eq . 23 \\ Q = {Q}_{1} + {Q}_{2} . & Eq . 24\end{matrix}$$

while other equations of interest include:

$$\begin{matrix}{F}_{12} = \frac{\frac{Δ {P}_{0}}{L} - \frac{Δ P}{L}}{\frac{Δ {P}_{0}}{L}} & Eq . 25 \\ \frac{Δ {P}_{0}}{L} = \frac{{ρ}_{1} {V}_{t}^{2} f}{4 {g}_{c} R} ; \\ f = {\{ - 2 log [ \frac{{ɛ}_{p}}{3.7} - \frac{5.02}{{Re}_{1}} log ( \frac{{ɛ}_{p}}{3.7} + \frac{14.5}{{Re}_{1}} ) ] \}}^{- 2} ; \\ {Re}_{1} = \frac{{ρ}_{1} {V}_{t} 2 R}{{μ}_{1}} . & Eq . 26 \\ {τ}_{w} = {τ}_{2 , zr} ( r = R ) = \frac{Δ P}{L} \frac{R}{2} . & Eq . 27 \\ {τ}_{b} = {τ}_{1 , zr} ( r = ( 1 - κ ) R ) = {τ}_{2 , zr} ( r = ( 1 - κ ) R ) = \frac{Δ P}{L} \frac{( 1 - κ ) R}{2} . & Eq . 28\end{matrix}$$

wherein f represents the friction factor for the turbulent phase; F represents the percentage friction reduction due to the addition of a friction reducing agent to the first (or inner) fluid; and F₁₂ represents the percentage friction reduction of this dual-phase flow compared to the friction pressure required to flow the inner turbulent phase only (i.e., for the case where κ=0).

As indicated in the above equations, the first (or inner) fluid and the second (or ring) fluid may travel through the tubular conduit at different bulk velocities, or flow rates. The flow rate of each fluid may depend on factors such as the configuration of the tubular conduit, the frictional forces from the interior surface of the tubular conduit, the pressure and temperature in the tubular conduit, the rate at which the fluid is introduced into the tubular conduit, the rheology of the fluid, and the frictional forces at the boundary of the first (or inner) fluid and the second (or ring) fluid. Therefore, the flow rates of the two fluids may differ. In many embodiments, the flow rates of both the first (or inner) fluid and the second (or ring) fluid may exceed 10 ft/sec. For example, each flow rate may be between about 10 ft/sec and about 200 ft/sec. In some embodiments, each flow rate may be between about 20 ft/sec and about 100 ft/sec.

As would be understood by a person of ordinary skill in the art with the benefit of this disclosure, for a given set of conditions, there exists a critical flow rate at and above which the ring fluid may exhibit turbulent flow. Determinative conditions may include the configuration of the tubular conduit, the frictional forces from the interior surface of the tubular conduit, the pressure and temperature in the tubular conduit, the rate at which the second (or ring) fluid is introduced into the tubular conduit, the rheology of the second (or ring) fluid, the thickness of the ring, and the frictional forces at the boundary of the first (or inner) fluid and the second (or ring) fluid. Such turbulence in the second (or ring) fluid may tend to cause the two fluids to mix. In some embodiments, conditions may be controlled to selectively initiate turbulence in the second (or ring) fluid and to thereby cause the two fluids to mix. For example, the interior surface of the tubular conduit at a particular location may be perforated, scored, pitted, ridged, or otherwise constructed to enhance the frictional forces. In other embodiments, a mixing tool (which may operate, for example, as a mechanical device, an explosive, an electromechanical charge, or a chemical reaction) may be selectively located within the tubular conduit to instigate mixing of the two fluids. In still other embodiments, the geometry of the tubular conduit may itself act as a mixing tool. Additionally, the rheology, flow rate, and thickness of the second (or ring) fluid may be adjusted to limit laminar flow in the ring to a selected elapsed time or depth in the tubular conduit.

Generally, the first (or inner) fluid and the second (or ring) fluid may be fluids commonly transported through tubular conduits. In some embodiments, the first (or inner) fluid and the second (or ring) fluid may be fluids commonly used in subterranean applications, in accordance with embodiments of the present invention, including, but not limited to aqueous fluids, non-aqueous fluids, gels, foams, emulsions, and viscosified fluids comprising one or more viscosifying agents. As used herein, the term “foam” and its derivatives refer to both instances of entrained gas, co-mingled gas, and gas bubbles that exist on the surface of a fluid. The term “viscosifying agent” is defined herein to include any substance that is capable of increasing the viscosity of a fluid, for example, by forming a gel. Some examples of viscosifying agents include, but are not limited to, gelling agents, emulsifiers, surfactants, salts, foamers, and friction reducing agents. In some embodiments, the first (or inner) fluid and the second (or ring) fluid may have similar or identical compositions. In some embodiments, the second (or ring) fluid may have a higher viscosity than the first (or inner) fluid. In other embodiments, the ratio of the viscosity of the first (or inner) fluid to that of the second (or ring) fluid may be between 1 and 10 as measured using a viscometer, such as a MCR 501 viscometer, commercially available from Anton Par of Austria. Suitable viscosities for the inner fluid may range from about 1 centipoise (“cp”) to about 100 cp at 100 s⁻¹ shear rate, and suitable viscosities for the ring fluid may typically exceed 10 cp at 100 s⁻¹ shear rate, both as measured using a MCR 501 viscometer at a temperature of about 25° C. and about 1 atmosphere of pressure. In some embodiments, the first (or inner) fluid may be substantially immiscible with the second (or ring) fluid. For example, the first (or inner) fluid may be a non-aqueous fluid, such as bitumen, heavy crude oil, or diesel, while the second (or ring) fluid may be an aqueous fluid, such as an aqueous gel; alternatively, the first (or inner) fluid may be an aqueous fluid, such as water, while the second (or ring) fluid may be a viscosified fluid comprising one or more viscosifying agents. In some embodiments, the first (or inner) fluid may be substantially soluble with the second (or ring) fluid.

Generally, the first (or inner) fluid may comprise any treatment fluid components used in subterranean operations, including, but not limited to, water, proppant particulates, iron-control inhibitors, scale inhibitors, sulfide scavengers, tackifiers, biocides, cross-linking agents, breakers, breaker catalysts, acids, acid generating agents (for example, acid-generating fluids as described in U.S. Patent Application Publication No. 2008/0078549, which is herein incorporated by reference), corrosion inhibitors, friction reducing agents, chelants, gel stabilizers, wetting agents, hydrocarbons, terpenes, polymers, alcohols, fluid loss control additives, diverting agents, relative permeability modifiers, clay stabilizers, bactericides, emulsifiers, demulsifiers, surfactants, emulsions, viscosifying agents, gelling agents, aqueous gels, viscoelastic surfactant gels, oil gels, foamed gels and emulsions. As used herein, the term “diverting agent” is defined to include any agent or tool (e.g., chemicals, fluids, particulates, or equipment) that is capable of altering some or all of the flow of a substance away from a particular portion of a subterranean formation to another portion of the subterranean formation or, at least in part, ensure substantially uniform injection of a treatment fluid over the region of the subterranean formation to be treated. As used herein, “fluid loss” refers to the migration or loss of fluids (for example, the fluid portion of a drilling mud, cement slurry, matrix treatment fluid, or fracturing fluid) into a subterranean formation. As used herein, “fluid loss control additives” include materials specifically designed to lower the volume of a filtrate that passes through a filter medium. As used herein, the term “treatment,” or “treating,” refers to any subterranean operation performed in conjunction with a desired function and/or for a desired purpose. The term “treatment,” or “treating,” does not imply any particular action. As used herein, the term “treatment fluid” refers generally to any fluid that may be used in a subterranean application in conjunction with a desired function and/or for a desired purpose, including, but not limited to, fracturing, acid fracturing, matrix treatments, and high-rate water fracturing. The term “treatment fluid” does not imply any particular action by the fluid or any component thereof. Suitable aqueous gels may generally comprise water and a viscosifying agent. Suitable emulsions may comprise two immiscible liquids, such as an aqueous liquid or gelled liquid and a hydrocarbon. Foams may be created by the addition of a gas, such as carbon dioxide or nitrogen. When used as a fracturing fluid, the first (or inner) fluid may be an aqueous gel that comprises water, a gelling agent for gelling the water and increasing its viscosity, and, optionally, a cross-linking agent for cross-linking the gel and further increasing the viscosity of the fluid. The increased viscosity of the gelled, or gelled and cross-linked, treatment fluid, inter alia, may reduce fluid loss and may allow the fracturing fluid to transport significant quantities of proppant particles. The water used to form the first (or inner) fluid may be freshwater, saltwater (e.g., water containing one or more salts dissolved therein), brine (e.g., produced from subterranean formations), or seawater, or combinations thereof, or any other aqueous liquid that does not adversely react with the other components. In some embodiments, when the composition of first (or inner) fluid includes water, the water may be fresh water, among other purposes, to provide improved rheology. In some instances, the first (or inner) fluid may include produced and/or recycled water to provide reduced costs. The density of the water may be increased, among other purposes, to provide additional particle transport and suspension in certain embodiments.

Generally, the second (or ring) fluid may comprise any treatment fluid components commonly used in subterranean operations, including water, proppant particulates, iron-control inhibitors, scale inhibitors, sulfide scavengers, tackifiers, biocides, cross-linking agents, breakers, breaker catalysts, acids, acid generating agents, corrosion inhibitors, friction reducing agents, gel stabilizers, wetting agents, hydrocarbons, terpenes, polymers, alcohols, fluid loss control additives, diverting agents, relative permeability modifiers, clay stabilizers, bactericides, emulsifiers, demulsifiers, surfactants, viscoelastic surfactants, emulsions, shear-thinning fluids (i.e., any fluid wherein the viscosity of the fluid decreases with rate of shear), viscosifying agents, gelling agents, aqueous gels, viscoelastic surfactant gels, oil gels, foamed gels and emulsions. Suitable aqueous gels may be generally comprised of water and one or more viscosifying agents. Suitable shear-thinning fluids include most typical gelling agents, natural or synthetic polymers, and/or viscoelastic surfactants. The concentration of shear-thinning fluid in the second (or ring) fluid may be adjusted to control the rheology of the second (or ring) fluid, thereby controlling the laminar flow profile of the ring. In some embodiments, the concentration of polymers used may be selected so that there is significant overlap between one polymer and another, thereby exhibiting shear-thinning behavior. Suitable emulsions may comprise two immiscible liquids, such as an aqueous liquid or gelled liquid and a hydrocarbon. Foams may be created by the addition of a gas, such as carbon dioxide or nitrogen. When used as a fracturing fluid, the second (or ring) fluid may be an aqueous gel that comprises water, a gelling agent for gelling the water and increasing its viscosity, and, optionally, a cross-linking agent for cross-linking the gel and further increasing the viscosity of the fluid. The increased viscosity of the gelled, or gelled and cross-linked, treatment fluid, inter alia, may reduce fluid loss and may allow the fracturing fluid to transport significant quantities of suspended proppant particles. The water used to form the second (or ring) fluid may be freshwater, saltwater (e.g., water containing one or more salts dissolved therein), brine (e.g., produced from subterranean formations), or seawater, or combinations thereof, or any other aqueous liquid that does not adversely react with the other components. In some embodiments, when the composition of the second (or ring) fluid includes water, the water may be fresh water, among other purposes, to provide improved rheology. In some instances, the second (or ring) fluid may include produced and/or recycled water to provide reduced costs. The density of the water optionally may be increased, among other purposes, to provide additional particle transport and suspension in the present invention.

For some applications, the composition of the first (or inner) fluid and/or the second (or ring) fluid may include friction reducing agents. Any friction reducing agent commonly used in subterranean operations may be appropriate. Examples of suitable friction reducing agents, include, but are not limited to, polyacrylamides, copolymers, polyacrylates, polyethylene oxide. For example, the composition of the second (or ring) fluid may include FR-46™, FR48™, FR56™, and/or SGA-HT® additive, each commercially available from Halliburton Energy Services, Inc. of Duncan, Okla. The amount of friction reducing agent included in the second (or ring) fluid may be at a concentration below, at, or above that which is commonly used in subterranean operations. For example, the concentration of the friction reducing agent in the second (or ring) fluid may be from about 1 to about 2000 pounds per 1000 gallons of solution (lbs/Mgal). In some embodiments, the concentration of the friction reducing agent in the second (or ring) fluid may be from about 10 to about 500 lbs/Mgal. In yet other embodiments, the concentration of friction reducing agent in the second (or ring) fluid may be from about 20 to about 200 lbs/Mgal.

For some applications, the first (or inner) fluid and/or the second (or ring) fluid may include one or more viscosifying agents. In some embodiments, the concentration of viscosifying agent in the second (or ring) fluid may be adjusted to control the rheology of the second (or ring) fluid, thereby controlling the laminar flow profile of the ring. Any viscosifying agent commonly used in subterranean operations may be appropriate. For example, suitable viscosifying agents may include, but are not limited to, natural biopolymers, synthetic polymers, cross linked viscosifying agents, viscoelastic surfactants, and the like. Guar and xanthan are examples of suitable viscosifying agents. A variety of viscosifying agents may be used, including hydratable polymers that contain one or more functional groups such as hydroxyl, carboxyl, sulfate, sulfonate, amino, or amide groups. Suitable viscosifying agents typically comprise polysaccharides, biopolymers, synthetic polymers, or a combination thereof. Examples of suitable polymers include, but are not limited to, guar gum and derivatives thereof, such as hydroxypropyl guar and carboxy-methylhydroxypropyl guar, cellulose derivatives, such as hydroxyethyl cellulose, locust bean gum, tara, konjak, tamarind, starch, cellulose, karaya, diutan, scleroglucan, succinoglycan, wellan, gellan, xanthan, tragacanth, and carrageenan, and derivatives and combinations of all of the above. Derivatives can include, for example, industrially manufactured chemical derivatives, bioengineered chemical derivatives, or naturally occurring derivatives produced by mutated organisms producing the polymer. As used herein, the term “derivative” includes any compound that is made from one of the listed compounds, for example, by replacing one atom in the listed compound with another atom or group of atoms, rearranging two or more atoms in the listed compound, ionizing one of the listed compounds, or creating a salt of one of the listed compounds. A preferred polymer is of the nature taught in U.S. Patent Application Publication No. 2006/0014648, which is incorporated herein by reference in its entirety. Additionally, synthetic polymers and copolymers may be used. Examples of such synthetic polymers include, but are not limited to, polyacrylate, polymethacrylate, polyacrylamide, polyvinyl alcohol, and polyvinylpyrrolidone. Commonly used synthetic polymer acid-gelling agents are polymers and/or copolymers consisting of various ratios of acrylic, acrylamide, acrylamidomethylpropane sulfonic acid, quaternized dimethyl-aminoethylacrylate, quaternized dimethylaminoethylmethacrylate, mixtures thereof, and the like. The viscoelastic surfactant may comprise any viscoelastic surfactant known in the art, any derivative thereof, or any combination thereof. As used herein, the term “viscoelastic surfactant” refers to a surfactant that imparts or is capable of imparting viscoelastic behavior to a fluid due, at least in part, to the association of surfactant molecules to form viscosifying micelles. These viscoelastic surfactants may be cationic, anionic, nonionic, or amphoteric/zwitterionic in nature. The viscoelastic surfactants may comprise any number of different compounds, including methyl ester sulfonates (e.g., as described in U.S. Patent Application Publication. Nos. 2006/0180308, 2006/0180309, 2006/0180310, and 2006/0183646, each of which is incorporated herein by reference in its entirety), hydrolyzed keratin (e.g., as described in U.S. Pat. No. 6,547,871, which is incorporated herein by reference in its entirety), sulfosuccinates, taurates, amine oxides, ethoxylated amides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives of any of the foregoing, and any combinations of any of the foregoing in any proportion. Suitable viscoelastic surfactants may comprise mixtures of several different compounds, including but not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; and any combination of the foregoing mixtures in any proportion. Examples of suitable mixtures of an ethoxylated alcohol ether sulfate surfactant, an alkyl or alkene amidopropyl betaine surfactant, and an alkyl or alkene dimethylamine oxide surfactant are described in U.S. Pat. No. 6,063,738, which is incorporated herein by reference. Examples of suitable aqueous solutions of an alpha-olefinic sulfonate surfactant and a betaine surfactant are described in U.S. Pat. No. 5,897,699, which is incorporated herein by reference in its entirety. Examples of commercially-available viscoelastic surfactants suitable for use in the present invention may include, but are not limited to, Mirataine® BET O-30 (an oleamidopropyl betaine surfactant available from Rhodia Inc., Cranbury, N.J.), AROMOX® APA-T (an amine oxide surfactant available from Akzo Nobel Chemicals, Chicago, Ill.), Ethoquad® O/12 PG (a fatty amine ethoxylate quat surfactant available from Akzo Nobel Chemicals, Chicago, Ill.), ETHOMEEN® T/12 (a fatty amine ethoxylate surfactant available from Akzo Nobel Chemicals, Chicago, Ill.), ETHOMEEN® S/12 (a fatty amine ethoxylate surfactant available from Akzo Nobel Chemicals, Chicago, Ill.), and REWOTERIC AM TEG™. (a tallow dihydroxyethyl betaine amphoteric surfactant available from Degussa Corp., Parsippany, N.J.). The amount of viscosifying agent included in the second (or ring) fluid may be below, at, or above that which is commonly used in subterranean operations. For example, the concentration of the viscosifying agent in the second (or ring) fluid may be from about 1 to about 2000 lbs/Mgal. For some embodiments, the concentration of the viscosifying agent in the second (or ring) fluid may be from about 10 to about 500 lbs/Mgal. In still other embodiments, the concentration of the viscosifying agent in the second (or ring) fluid may be from about 20 to about 200 lbs/Mgal. In those embodiments wherein the viscosifying agent comprises a viscoelastic surfactant, the concentrations may be somewhat greater. In many embodiments, the second (or ring) fluid may have a higher concentration of viscosifying agents than the first (or inner) fluid.

In some embodiments, such as in water frac applications, for example, tubular conduit friction and proppant erosion may be reduced by controlling the rheology of the second (or ring) fluid. As used herein, the terms “water frac” or “high-rate water fracturing” generally refer to the use of non-gelled, linear gelled, or lightly-gelled water as a fracturing fluid. Typically, water fracs consist of pumping large volumes of water with low proppant concentrations. High-rate water fracturing is often utilized in subterranean formations with low permeability (e.g., no more than about 0.1 millidarcy). Unlike conventional fracturing fluids, fluids used in high-rate water fracturing generally do not contain a sufficient amount of a water-soluble polymer to form a strong or stiff gel (e.g., a crosslinked fluid). Gel formation is generally based on a number of factors including the particular polymer and concentration thereof, temperature, and a variety of other factors known to those of ordinary skill in the art. As a result, the fracturing fluids used in these high-rate water fracturing operations generally have a lower viscosity than traditional fracturing fluids. Controlling the rheology of the second (or ring) fluid may be accomplished, for example, by controlling the type and concentration of polymer used in the aqueous solution. The inner fluid may comprise turbulent phase water and proppant. The second (or ring) fluid may be essentially free of proppant, in that no proppant is added to the second (or ring) fluid. Without limiting the invention to a particular theory or mechanism of action, it is nevertheless currently believed that friction may be reduced in two ways: 1) by reducing or eliminating friction due to surface irregularities at tubular conduit connections and/or roughness on the interior surface of the tubular conduit, and 2) by reducing friction due to turbulent velocity while maintaining the total flow rate of the first (or inner) fluid. As a mechanism for reducing or eliminating friction due to surface irregularities, it is currently believed that the viscoelastic nature of the second (or ring) fluid may prevent turbulent eddies from emanating from surface irregularities at tubular conduit connections and/or roughness on the interior surface of the tubular conduit. As a mechanism for reducing or eliminating friction due to turbulent velocity, it is currently believed that the flow of the second (or ring) fluid may guide the flow of the turbulent phase, proppant-laden inner fluid down the tubular conduits. The second (or ring) fluid may also shield the interior surface of the tubular conduit, thereby providing protection to tubular conduits from proppant erosion.

In some embodiments, such as acid fracturing operations, for example, tubular conduit corrosion may be reduced by controlling the composition, rheology, and flow rate of the second (or ring) fluid. The second (or ring) fluid may be non-acidic. This may prevent or significantly reduce corrosion to tubular conduits from an acidic first (or inner) fluid. Moreover, the second (or ring) fluid may comprise a corrosion inhibitor, further protecting the interior surfaces of the tubular conduits. Some exemplary corrosion inhibitors may include HAI-85M™ Acid Corrosion Inhibitor, HAI-404M™ Acid Corrosion Inhibitor, MSA-II™ Corrosion Inhibitor, HAI-303™ Environmental Hydrochloric Acid Corrosion Inhibitor, and MSA-III™ Corrosion Inhibitor for Organic Acids, each of which is commercially available from Halliburton Energy Services, Inc., of Duncan, Okla.

In certain embodiments of the invention, the compositions of the first (or inner) and second (or ring) fluids may be selected to perform specific functions at one or more designated depths. For example, it may be desirable to isolate breakers from breaker catalysts until the fluids reach a desired depth, corresponding to a selected zone of the subterranean formation. In such embodiments, the first (or inner) fluid may transport a first set of chemicals down a tubular conduit simultaneously with another second set of chemicals which may be included in the second (or ring) fluid. “Zone” as used herein simply refers to a portion of the formation and does not imply a particular geological strata or composition. As previously discussed, conditions may be selected to initiate mixing at a desired depth. CFD may be utilized to estimate a mixing depth. Field testing also may be utilized to refine the estimate. The injection mechanism, fluid volumes, fluid compositions, and other parameters especially as related to relative viscosities, may be selected to preserve chemical segregation as a function of time or depth. As previously discussed, this method may be applicable to operations utilizing exothermic chemical reactions. This method also may be applicable for use with DTS applications. Other applications which may benefit from delayed mixing of a first set of chemicals and a second set of chemicals include the downhole use of catalysts and breakers, reactors and activators, and various other incompatible compounds (e.g., hydrocarbons or glycols and viscoelastic fluids).

In some embodiments, the second (or ring) fluid may act as a diverting agent for the first (or inner) fluid. For example, the first (or inner) fluid may comprise an acid or acid generating agent, while the second (or ring) fluid may comprise a corrosion inhibitor. As another example, the first (or inner) fluid may comprise a treatment fluid designated for application at a certain depth, corresponding to a selected zone of the subterranean formation, while the second (or ring) fluid comprises a fluid loss control additive, inter alia, to reduce the permeability of the formation above that depth.

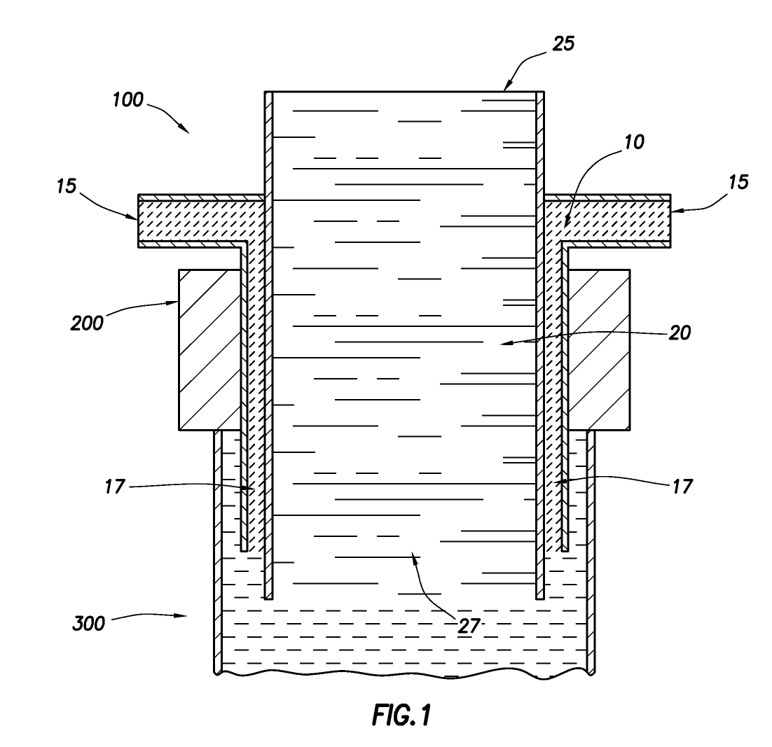

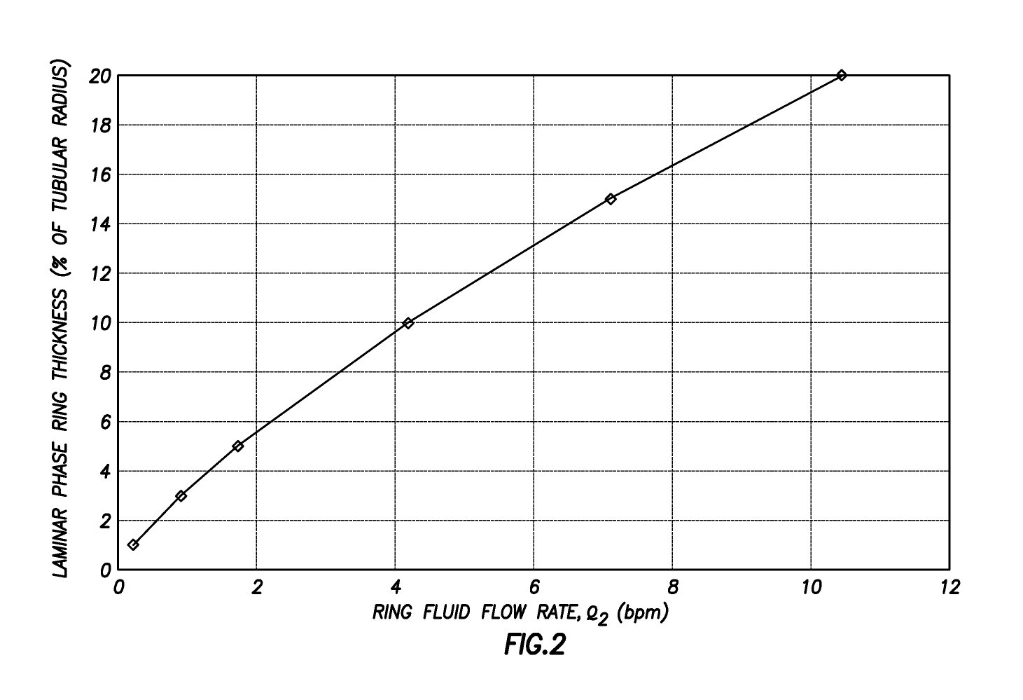

In the methods of the present invention, the second (or ring) fluid may be disposed annularly between the first (or inner) fluid and the interior of the tubular conduit using any suitable technique, including techniques commonly used to create multi-phase fluid flows. In some embodiments of the invention, a laminar phase ring may be created by introducing a first (or inner) fluid into the central region of the tubular conduit. A second (or ring) fluid may be introduced into the tubular conduit with the use of an annular delivery system. The annular delivery system may comprise one or more pumping or injecting systems, multiple supply sources and delivery lines, concentric tubing, and/or a specialized injection nozzle. For example, FIG. 1 illustrates a schematic of a specialized injection nozzle 100 attached to wellhead 200. The ring fluid 10 may be introduced into well casing 300 through ring fluid injection ports 15 and ring fluid channels 17. The inner fluid 20 may be introduced into well casing 300 through inner fluid injection port 25 and inner fluid tubular 27. Specialized injection nozzle 100 may, thereby, introduce the multiphasal fluid into well casing 300. The rate at which each fluid is introduced into the tubular conduit may be controlled, among other purposes, to adjust the radial thickness of the laminar phase ring. For example, FIG. 2 illustrates how ring thickness may vary with the rate of introduction of ring fluid into a tubular conduit. As illustrated, Q₁=60 bpm, R=4.3″, εₚ=1×10⁻⁴, m₂=4000 cP_ŝ(n₂−1), n₂=0.4, and F=0%. In some embodiments, pumping of the ring fluid may precede pumping of the inner fluid. The initial pumping of ring fluid may thereby substantially fill the cross-sectional area of the tubular conduit. Subsequent pumping of the inner fluid may be directed do penetrate the central portion of the flow of ring fluid, creating a finger of inner fluid within the ring fluid. Some embodiments may require the use of multiple pumps with independent pumping rates to appropriately deliver the inner fluid and ring fluid. In other embodiments, a single pump and/or pumping rate may suffice.

The radial thickness of the laminar phase ring of the present invention may be selected to provide the desired reduction of friction, tubular conduit protection, fluid separation, and/or other desired results. In some embodiments, a laminar phase ring of the present invention may be present with a κ value in the range of from about 0.1% to about 10%, wherein the κ value expresses the radial thickness of the laminar phase ring as a percentage of the radius of the tubular conduit. The κ value may be calculated, as in the above equations. Additionally, the κ value may be measured, for example, approximately 200 to 1000 feet downhole from the point of insertion of the laminar phase ring. In other embodiments, the κ value may be as high as 20%. However, radial thicknesses of the laminar phase ring outside this range also may be suitable for use in embodiments of the present invention.

Generally, the methods of the present invention may be used in any fluid transport operation. In some embodiments, the fluid transport may be applicable to subterranean operations. Such subterranean operations include, but are not limited to, drilling operations, stimulation treatments (e.g., fracturing treatments, acidizing treatments, fracture acidizing treatments), production, processing, and completion operations. Those of ordinary skill in the art, with the benefit of this disclosure, will be able to recognize suitable subterranean operations where friction reduction, fluid separation, and/or tubular conduit protection may be desired.

Some embodiments of the present invention may provide methods beneficial to designing well treatments. For example, for a given downhole configuration and treatment fluid, CFD or experimentation may predict an expected friction profile of the treatment. A second (or ring) fluid may be selected to be pumped with the treatment fluid (wherein the treatment fluid would act as the first (or inner) fluid, and the second (or ring) fluid would have laminar flow) to improve the expected friction profile of the treatment.

While the tubular conduits have been discussed with reference to depth, it would be understood by one of ordinary skill in the art that the methods described herein may be applicable to tubular conduits in vertical, horizontal, or diagonal orientations. The tubular conduits may be substantially linear, while, in some embodiments, the tubular conduits may have bends, curves, or angles.

While most of the description has referred to only two fluids, one of ordinary skill in the art would recognize that more than two fluids could be used to create the multi-phase fluid flow, thereby forming multiple laminar rings.

To facilitate a better understanding of the present invention, the following examples of certain aspects of some embodiments are given. In no way should the following examples be read to limit, or define, the scope of the invention.

### EXAMPLES

### Example 1

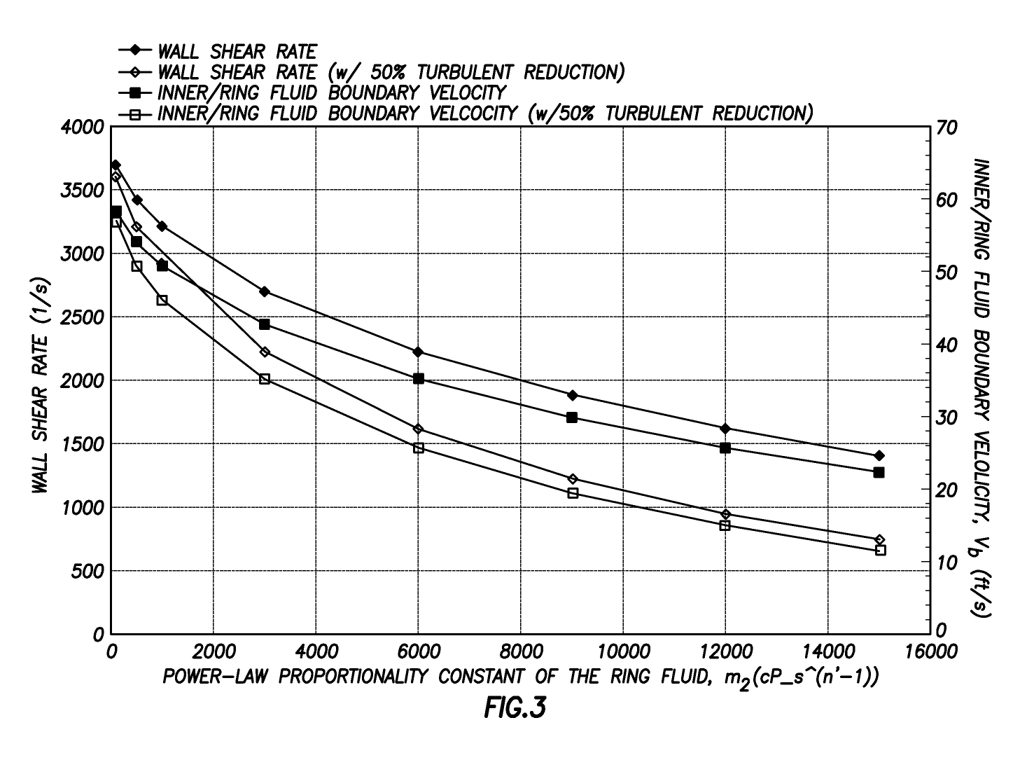

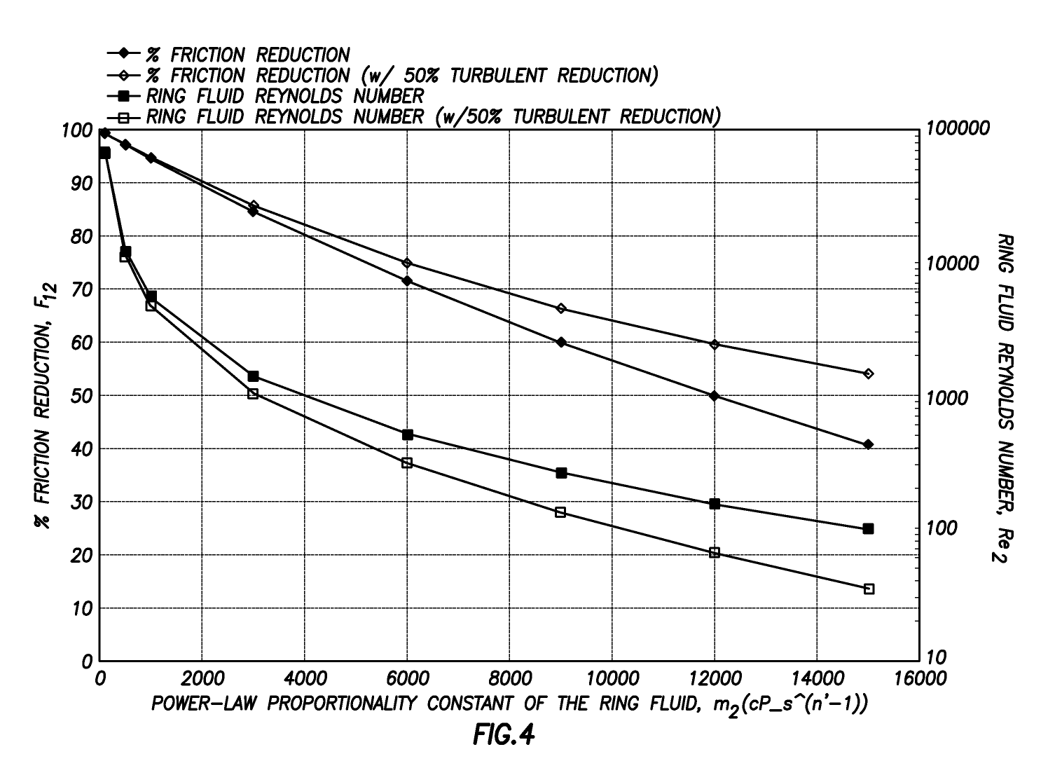

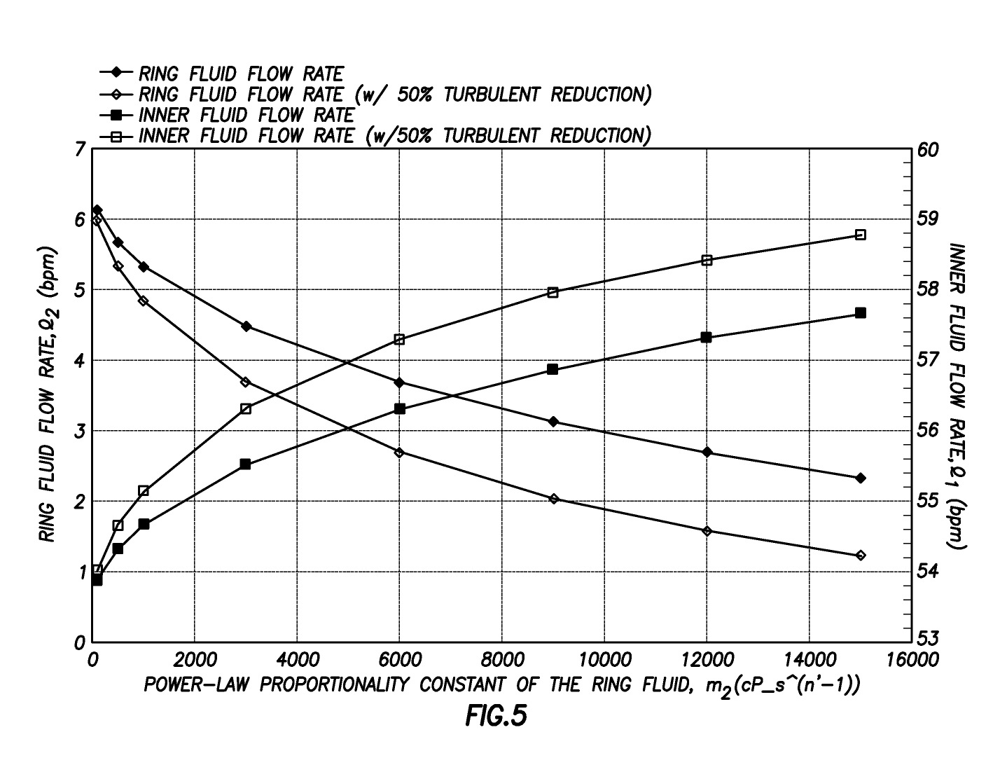

The rheology of the ring fluid may be tuned to provide desired friction reduction properties. For example, at a total flow rate of 60 barrels per minute down a tubular conduit with an inside diameter of 4.3 inches and a relative roughness factor of 1×10⁻⁴, a laminar phase ring with a thickness corresponding to a κ value of 10% may be used to reduce the turbulent friction of water flowing inside the laminar phase ring. The composition of the ring fluid in the laminar phase ring may include a shear-thinning, viscoelastic fluid with rheology that may be represented with the Power Law constants m₂ and n₂. The rheology of this viscoelastic fluid may be tuned by adjusting m₂ and holding n₂ constant at 0.4. FIGS. 3 through 5 illustrate various properties of one embodiment of the invention with and without the turbulent reduction by conventional means. FIG. 3 illustrates the wall shear rate and the inner/ring fluid boundary velocity as a function of m₂. FIG. 4 illustrates the percent friction reduction and the ring fluid Reynolds number as a function of m₂. FIG. 5 illustrates the ring fluid flow rate and the inner fluid flow rate as a function of m₂. As illustrated in FIGS. 3-5, Q₁=60 bpm, R=4.3″, εₚ=1×10⁻⁴, n₂=0.4, and κ=10%.

### Example 2

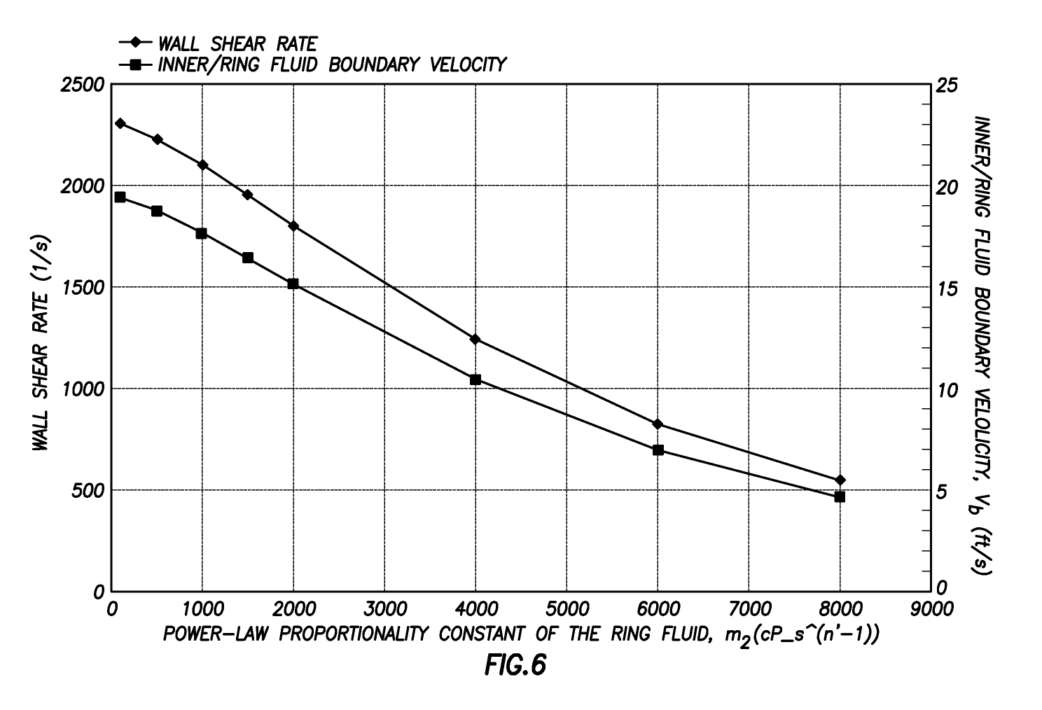

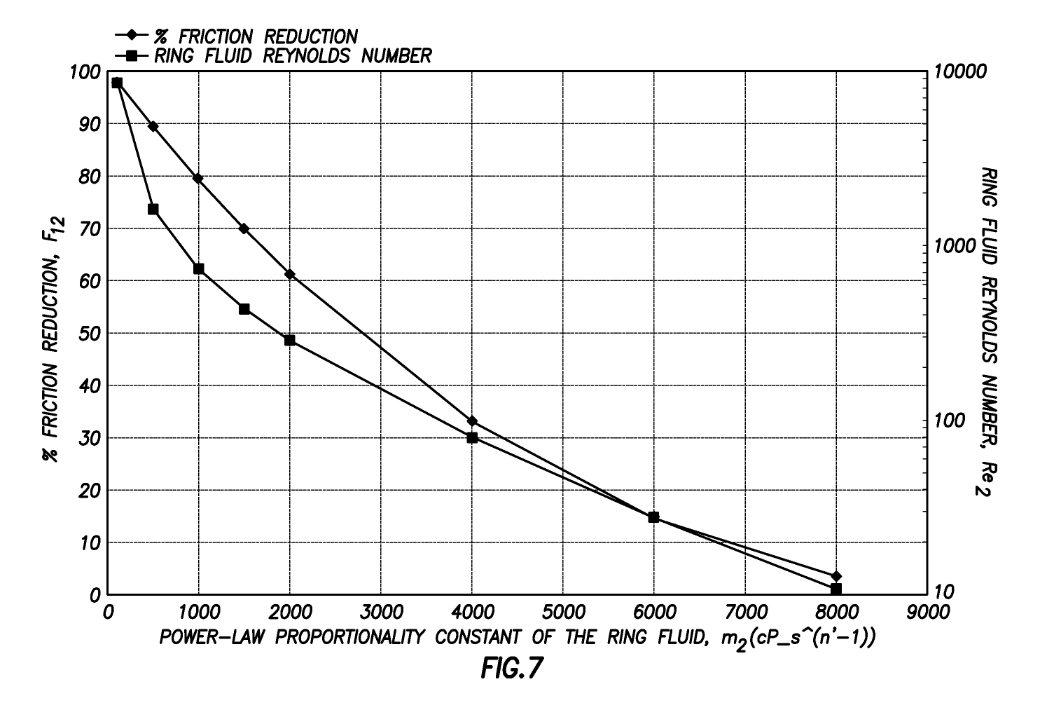

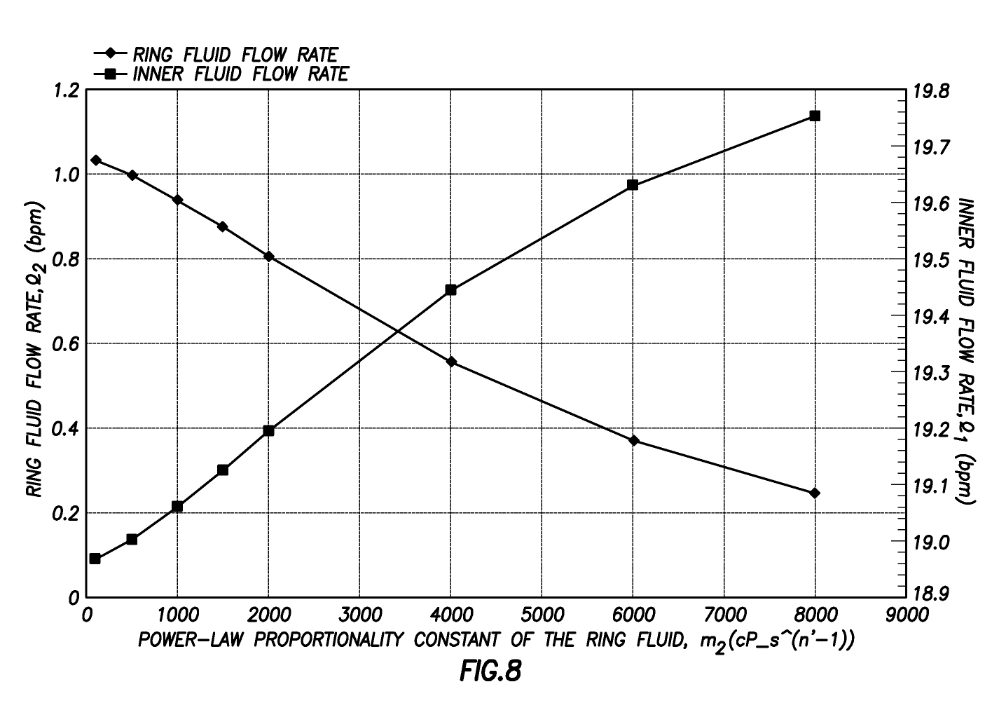

The rheology of the ring fluid may be tuned to provide desired friction reduction properties. For example, at a total flow rate of 20 barrels per minute down a tubular conduit with an inside diameter of 4.3 inches, a laminar phase ring with a thickness corresponding to a κ value of 5% may be used to reduce the friction of a viscous fluid flowing inside the laminar phase ring. The composition of the ring fluid may include a shear-thinning, viscoelastic fluid with rheology that may be represented with the Power Law with constants m₂ and n₂, and the viscous inner fluid flowing inside the laminar phase ring may have rheology that is defined by the Power Law with constants m₁=1125 cP·s^{(n′-1)} and n₁=0.74. The rheology of the ring fluid may be tuned by adjusting m₂ and holding n₂ constant at 0.4. FIGS. 6 through 8 illustrate various properties of one embodiment of the invention. FIG. 6 illustrates the wall shear rate and the inner/ring boundary velocity as a function of m₂. FIG. 7 illustrates the percent friction reduction and the ring fluid Reynolds number as a function of m₂. FIG. 8 illustrates the ring fluid flow rate and the inner fluid flow rate as a function of m₂. As illustrated in FIGS. 6-8, Q₁=20 bpm, R=4.3″, n₂=0.4, m₁=1125 cP_ŝ(n₁−1), n₁=0.74, and κ=5%.

Therefore, the present invention is well adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. In particular, every range of values (of the form, “from about a to about b,” or, equivalently, “from approximately a to b,” or, equivalently, “from approximately a−b”) disclosed herein is to be understood as referring to the power set (the set of all subsets) of the respective range of values, and set forth every range encompassed within the broader range of values. Consequently, the invention is intended to be limited only by the spirit and scope of the appended claims, giving full cognizance to equivalents in all respects. The terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted for the purposes of understanding this invention.

What is claimed is:

1. A method comprising:
introducing an inner fluid into a tubular conduit; and
introducing a ring fluid into the tubular conduit, wherein the ring fluid is disposed annularly between the inner fluid and the interior of the tubular conduit, and wherein the flow of the ring fluid is laminar.

2. The method according to claim 1, wherein the inner fluid comprises proppant, and the ring fluid comprises a friction reducing agent.

3. The method according to claim 1, wherein the inner fluid comprises at least one component selected from the group consisting of: an acid, an acid generating agent, any combination thereof, and any derivative thereof.

4. The method according to claim 1, wherein the inner fluid reacts with the ring fluid exothermically.

5. The method according to claim 1, wherein the viscosity of the inner fluid is no greater than about 10 times the viscosity of the ring fluid.

6. The method according to claim 1, wherein
the inner fluid comprises a non-aqueous fluid;
the ring fluid comprises an aqueous fluid; and
the inner fluid is substantially immiscible with the ring fluid.

7. The method according to claim 1, wherein the inner fluid comprises an aqueous fluid, and the ring fluid comprises a viscosified fluid.

8. The method according to claim 1, wherein the inner fluid comprises at least one component selected from the group consisting of: a breaker, a breaker catalyst, any combination thereof, and any derivative thereof.

9. The method according to claim 1, wherein the ring fluid comprises at least one component selected from the group consisting of: a friction reducing agent, a fluid loss control additive, a corrosion inhibitor, a diverting agent, a relative permeability modifier, a viscosifying agent, a viscoelastic surfactant, a clay stabilizer, a shear-thinning fluid, any combination thereof, and any derivative thereof.

10. The method according to claim 1, wherein the ring fluid comprises a friction reducing agent in a concentration of from about 1 to about 2000 lbs/Mgal.

11. The method according to claim 1, wherein the ring fluid is introduced into the tubular conduit via an annular delivery system.

12. The method according to claim 1, wherein introducing the ring fluid into the tubular conduit precedes introducing the inner fluid into the tubular conduit.

13. The method according to claim 1, wherein the radial thickness of the ring fluid is about 0.1% to about 20% of an inner radius of the tubular conduit.

14. A method comprising:
providing a tubular conduit;
providing a first fluid to flow through the tubular conduit;
determining an expected friction between the interior of the tubular conduit and the first fluid during flow of the first fluid through the tubular conduit; and
selecting a second fluid to flow through the tubular conduit so that an expected friction between the interior of the tubular conduit and the second fluid during flow of the second fluid through the tubular conduit would be less than the determined expected friction between the interior of the tubular conduit and the first fluid, wherein:
the second fluid is disposed annularly between the first fluid and the interior of the tubular conduit during flow of the second fluid through the tubular conduit; and
the flow of the second fluid is laminar.

15. A method for treating a portion of a subterranean formation comprising:
providing a treatment zone in a well bore proximate the portion of the subterranean formation;
providing a tubular conduit that is disposed in the well bore proximate the treatment zone;
introducing an inner fluid into the tubular conduit;
introducing a ring fluid into the tubular conduit, wherein the ring fluid is disposed annularly between the inner fluid and the interior of the tubular conduit, and wherein the flow of the ring fluid is laminar; and
initiating mixing of the inner fluid and the ring fluid at the treatment zone.

16. The method according to claim 15, wherein initiating mixing comprises providing an interior surface of the tubular conduit proximate the treatment zone which enhances frictional forces.

17. The method according to claim 15, wherein initiating mixing comprises disposing a mixing tool proximate the treatment zone.

18. The method according to claim 15, wherein initiating mixing comprises controlling a parameter so that mixing of the inner fluid and the ring fluid occurs primarily at or beyond the treatment zone, wherein the parameter comprises at least one parameter selected from a group consisting of: a rheology of the ring fluid, a thickness of the ring fluid, and a flow rate of the ring fluid.

19. The method according to claim 15, further comprising:
monitoring temperature in the well bore; and
observing a variation in a temperature gradient along at least a portion of an interval of interest.

20. The method of according to claim 18, wherein observing a variation in temperature gradient occurs in real time.
